(19) United States
(12) Patent Application Publication
(10) Pub. No.: US 2004/0230819 A1
(43) Pub. Date: Nov. 18, 2004

(54) Magnetic disk apparatus, cipher processing method and program

(75) Inventor: Tsuneki Takahashi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/784,700

(22) Filed: Feb. 23, 2004

(30) Foreign Application Priority Data
May 15, 2003 (JP) 2003-136867

(51) Int. Cl. G06F 12/14

(52) U.S. Cl. 713/193

(57) ABSTRACT

A cipher key used for encoding and decoding of data is stored in a cipher key memory unit. A cipher encode unit encodes data input from an upper apparatus via a host interface using the cipher key and records it onto a record medium. A cipher decode unit decodes the encoded data read out from the record medium using the cipher key and outputs it via the host interface to the upper apparatus. When a magnetic disk apparatus is discarded, the decoding is made impossible by changing the cipher key stored in the cipher key memory unit with a cipher key change unit.

### BACKGROUND OF THE INVENTION

1. Field of the Invention

The present invention relates generally to a magnetic disk apparatus whose medium storage data disappears when a computer is discarded, a cipher processing method and program associated therewith, and, more particularly, to a magnetic disk apparatus that uses a cipher processing to disappear the medium storage data, a cipher processing method and program associated therewith.

2. Description of the Related Arts

Traditionally, when a used computer is discarded or reused, it is needed to prevent outflow of data recorded on a magnetic disk apparatus. Such methods for preventing outflow of data on a magnetic disk apparatus can include a method which erases data, a method which records encoded data and a method which physically destroys the magnetic disk apparatus (See, e.g., Japan Patent Application Laid-open Pub. No. 2001-092719).

However, those methods for preventing outflow of data on a magnetic disk apparatus have following problems. First, when data on a magnetic disk apparatus is erased, considered cases are that the data is completely erased from the magnetic disk apparatus and that the data simply can not be seen from OS but the data itself is not erased from the magnetic disk apparatus in the light of subsequent data recovery. However, it is difficult to comprehend difference between these data erasures for a user, and in the case of the data erasure that the data simply can not be seen from OS, a problem of outflow of data may occur. Also, if the data is completely erased, there is a problem that considerable time is needed to erase all the data, in connection with recent enlargement of capacities of the magnetic disk apparatuses.

Further, in the case that data of the magnetic disk apparatus is encoded, since the data and its cipher key are handled separately and, if the data outflows, it is not possible to decode, the security is maintained. However, the magnetic disk apparatuses are used for startup of computers in many cases, and it is difficult to encode OS as well. In other words, if all the data, including OS, recorded on the magnetic disk apparatus is encoded, the computer side needs to be provided with an OS-independent dedicated encoding decoding function for restoring the encoded data read out from the magnetic disk apparatus, and a computer with out the encoding decoding function can not utilize the data. Also, if the data of the magnetic disk apparatus is encoded, since the data and its cipher key are handled separately, there is a problem that a user is imposed the burden of management of the cipher key. Further, in a method that the magnetic disk apparatus is physically destroyed, outflow of data is certainly prevented, but since operable devices are destroyed and that devices can not be reused, a problem about cost is posed.

### SUMMARY OF THE INVENTION

According to the present invention there is provided a magnetic disk apparatus, cipher processing method and program for easily and certainly prevent outflow of data, using a encoding technology. The magnetic disk apparatus of the present invention comprises a cipher key memory unit which stores a cipher key used for encoding and decoding data; a cipher encode unit which encodes data input via an interface from an upper apparatus using the cipher key, the cipher encode unit recording the encoded data onto a record medium; a cipher decode unit which decodes the encoded data read out from the record medium using the cipher key, the cipher decode unit outputting the decoded data via the interface to the upper apparatus; and a cipher key change unit which changes a cipher key stored in the cipher key memory unit.

In the magnetic disk apparatus of the present invention, since data recorded on record medium is encoded, when the magnetic disk apparatus of the present invention is discarded or diverted, the cipher key is changed. When the cipher key is changed this way, since encoded data recorded in the medium is data encoded with the cipher key before changing, if decoded with the encoded key after changing, correct data will not be decoded and only senseless data will be decoded. Therefore, with a simple operation of changing the cipher key held by the magnetic disk apparatus, all the data in the recording area, including OS, can be discarded, without performing erasure in the whole recording area. Also, in the magnetic disk apparatus of the present invention, since data encoding and decoding is performed within the magnetic disk apparatus, the data via the interface is the same as that of a conventional magnetic disk apparatus, and on the computer side, all the data including OS can be handled same way as that of the conventional magnetic disk apparatus. Therefore, a dedicated encoding process function is not needed on the computer side.

Further, in the magnetic disk apparatus of the present invention, the encoded data and the cipher key are stored and used within the apparatus, so a user does not have to manage the cipher key in general use. The user only have to change the cipher key when the magnetic disk apparatus is discarded or diverted, so the user's burden associated with management of the cipher key is reduced. Further, in the magnetic disk apparatus of the present invention, since the data is discarded by changing the cipher key, functions of the apparatus are not lost after changing the cipher key, and the magnetic disk apparatus is returned to unused condition by changing the cipher key, so by starting from install of OS for reusing a computer, the computer can be reused as a unused apparatus. It is noted that the cipher key storage unit stores a predefined cipher key written in the manufacturing stage of the apparatus. The cipher key memory unit uses nonvolatile memory. Also, the cipher key memory unit may be a recording area in the record medium other than the user recording area. The cipher key change unit changes the cipher key stored in the cipher key memory unit when all the recorded data residing in the user recording area on the record medium is discarded collectively. The cipher key change unit changes the cipher key in the cipher key memory unit according to a special command other than a command system for an upper apparatus. This special command is independent from OS, so the cipher key is prevented from being accidentally changed during operation. The cipher key change unit changes the cipher key in the cipher key memory unit according to a special command from a cipher key change application installed in the upper apparatus.

Also, the cipher key change unit changes the cipher key in the cipher key memory unit according to a special command from the cipher key change application installed by the upper apparatus via network. Therefore, when discarding the data of the magnetic disk apparatus, the cipher key within the magnetic disk apparatus can be changed using the application provided from removable medium, such as FD, or by referring to the web site of the manufacturer, and management of the cipher key by the user is not necessary at all. The cipher key change unit changes the cipher key in the cipher key memory unit by recognizing physical event manipulation in the apparatus. In this way, it is possible to change the cipher key by recognizing manipulation in the apparatus, such as DIP switch manipulation, signal input to a certain pin and disconnection of a jumper line. The cipher key change unit changes the cipher key by generating a new cipher key with, for example, the shuffling process of the cipher key stored in the cipher key memory unit. Also, the cipher key change unit may change the cipher key stored in the cipher key memory unit into another cipher key added to a cipher key change command from the upper apparatus.

According to the present invention there is provided a cipher processing method for a magnetic disk apparatus. The cipher processing method comprises:

a cipher key memory step of storing in a memory unit a cipher key used for encoding and decoding data;

an encoding/recording step of converting data input via an interface from an upper apparatus into encoded data using the cipher key, and storing the encoded data onto a record medium;

a decoding/readout step of decoding the encoded data read out from the record medium using the cipher key, and outputting the decoded data via the interface to the upper apparatus; and

a cipher key change step of changing a cipher key stored in the cipher key memory unit. The cipher key change step includes changing the cipher key stored in the cipher key memory unit when all the record data residing in a user recording area on the record medium is discarded collectively.

According to the present invention there is provided a program executed by a computer incorporated in a magnetic disk apparatus. The program is operable to cause the computer to execute:

a cipher key memory step of storing in a memory unit a cipher key used for encoding and decoding data;

an encoding/recording step of converting data input via an interface from an upper apparatus into encoded data using the cipher key, and storing the encoded data onto a record medium;

a decoding/readout step of decoding the encoded data read out from the record medium using the cipher key, and outputting the decoded data via the interface to the upper apparatus; and

a cipher key change step of changing a cipher key stored in the cipher key memory unit. The cipher key change step includes changing the cipher key stored in the cipher key memory unit when all the record data residing in a user recording area on the record medium is discarded collectively.

The other details of the cipher processing method and program will become basically the same as those of the apparatus configuration of the magnetic disk apparatus.

The above and other objects, features, and advantages of the present invention will become more apparent from the following detailed description with reference to the drawings.

### BRIEF DESCRIPTION OF THE DRAWINGS

FIGS. 1A and 1B are block diagrams of a magnetic disk apparatus according to the present invention, in which a encoding process is executed by hardware;

FIGS. 2A and 2B are block diagrams of a magnetic disk apparatus according to the present invention, in which a encoding process is executed by a program;

FIG. 3 is a block diagram of a functional structure of a program encoding process according to the present invention;

FIG. 4 is a flowchart of a encoding process in the present invention;

FIG. 5 is an explanatory diagram of network environment providing a cipher key change tool to the magnetic disk apparatus of the present invention;

FIG. 6 is an explanatory diagram of the user management file in the manufacturer's server of FIG. 5;

FIG. 7 is an explanatory diagram of an operating screen of a hard disk discard tool installed in the browser of FIG. 5;

FIG. 8 is a block diagram of another embodiment of the present invention, in which the cipher key is changed with a changing manipulation part in the apparatus;

FIG. 9 is a block diagram of another embodiment of the present invention, in which the cipher key is stored in record medium; and

FIG. 10 is a block diagram of another embodiment of the present invention, in which the cipher key is stored in record medium to change the cipher key with a changing manipulation part in the apparatus.

### DETAILED DESCRIPTION OF THE PREFERRED EMBODIMENT

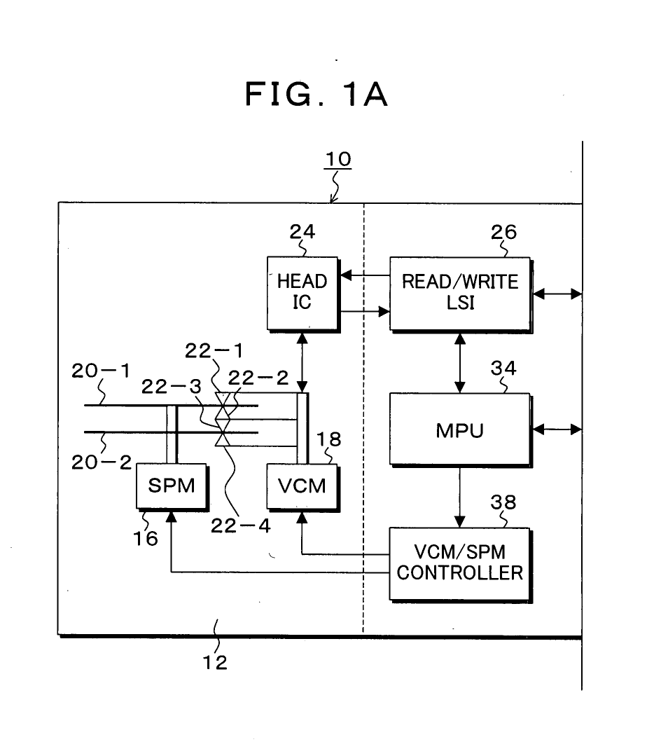

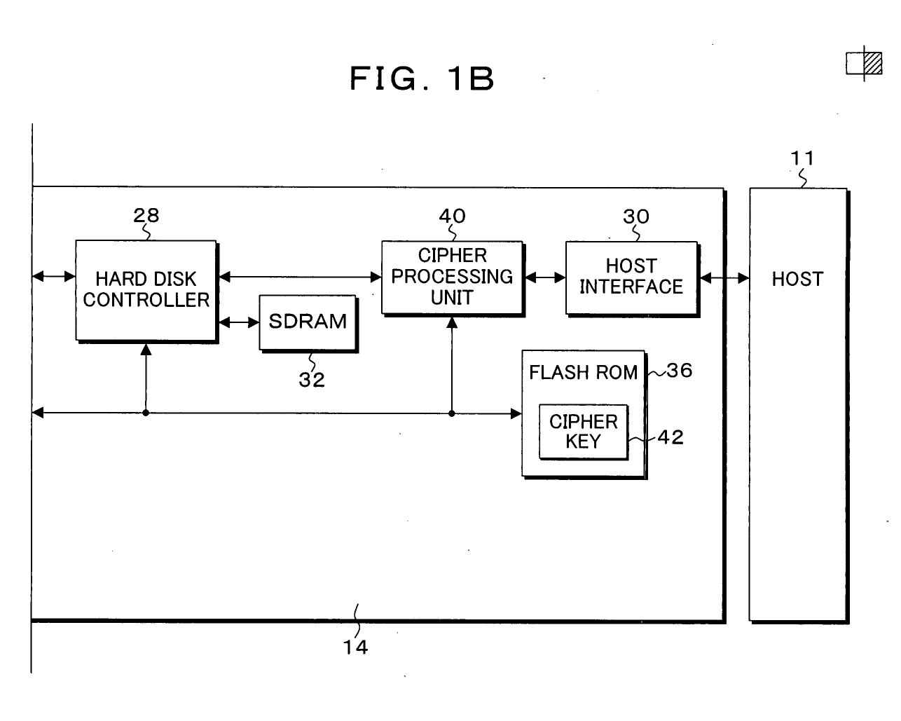

FIGS. 1A and 1B are block diagrams of a magnetic disk apparatus to which a encoding process of the present invention is applied. In FIGS. 1A and 1B, a hard disk drive (HDD) as the magnetic disk apparatus consists of a disk enclosure 12 and a control board 14. The disk enclosure 12 is provided with a spindle motor 16, and an axis of rotation of the spindle motor 16 is mounted with magnetic disk medium 20-1 and 20-1 and rotates it at a constant rate. Also, the disk enclosure 12 is provided with a voice coil motor 18, and the voice coil motor 18 is equipped with heads 22-1 to 22-4 at ends of arms of a head actuator and performs positioning of the heads to recording surfaces. It is noted that the heads 22-1 to 22-4 are integrally equipped with a write heads and read heads. The heads 22-1 to 22-4 are connected with a head IC 24 by signal lines, and the head IC 24 selects any one head which performs writing or reading according to a head select signal based on a write or a read command from a host 11 which is an upper apparatus. Also, the head IC 24 is provided with a write amplifier for a write system and a preamplifier for a read system. The control board 14 is provided with a read/write LSI 26, a hard disk controller (HDC) 28, a host interface 30, SDRAM 32, MPU 34, a flash ROM 36 and a VCM/SPM controller 38. In addition to these, in the present invention, the control board 14 is newly provided with a encoding processing unit 40. In this embodiment, a cipher key 42 used in the encoding processing unit 40 is stored in the flash ROM 36 which is nonvolatile memory. The storage of the cipher key 42 to the flash ROM 36 is performed in the manufacturing stage of the magnetic disk apparatus 10, using a special command.

The operation of the magnetic disk apparatus 10 is briefly described as follows. When a write command and write data from the host 11 is received by the host interface 30, the write command is decoded by MPU 34, and the received write data, including buffering data in SDRAM 32 which acts as a transfer buffer if necessary, is converted to predefined formatted data and ECC code is added in the hard disk controller 28, then after scrambling, RLL code conversion and write phase compensation is performed in the write system of the read/write LSI 26, it is written on the magnetic disk by the write head of the head selected via the head IC 24. At this point of time, a head positioning signal is given to the VCM/SPM controller 38 and the head is positioned by the voice coil motor 18 to the position instructed by the command. On the other hand, in read operation, after inputting a read signal read out from the read head selected by the head selecting of the head IC 24 into the read/write LSI 26 and demodulating read data according to partial response maximum-likelihood detection (PRML), errors are detected and corrected by executing ECC process in the hard disk controller 28, and then, the read data is transferred from the host interface 30 to the host 11 via buffering of SDRAM 32 as the transfer buffer.

In the present invention, for these writing of the write data and reading of the read data in the magnetic disk apparatus, the encoding processing unit 40, which is achieved by functions of hardware or firmware, is newly provided to a preceding portion of the host interface 30. When the write data received by the host interface 30 is transferred to the hard disk controller 28, the encoding processing unit 40 encodes the write data using key codes “a1 to an” of the cipher key 42 stored in the flash ROM 36, and after formatting the encoded data in the hard disk controller 28, ECC code is added to it, and the data is written on the magnetic disk from the read head selected at this point, via the read/write LSI 26 and the head IC 24. On the other hand, for the signal read out from the magnetic disk apparatus, the encoded read data connected by the hard disk controller 28 is input into the encoding processing unit 40, then the encoded data is decoded using the key codes “a1 to an” of the cipher key 42 stored in the flash ROM 36, and the decoded data is transferred to the host via the host interface 30.

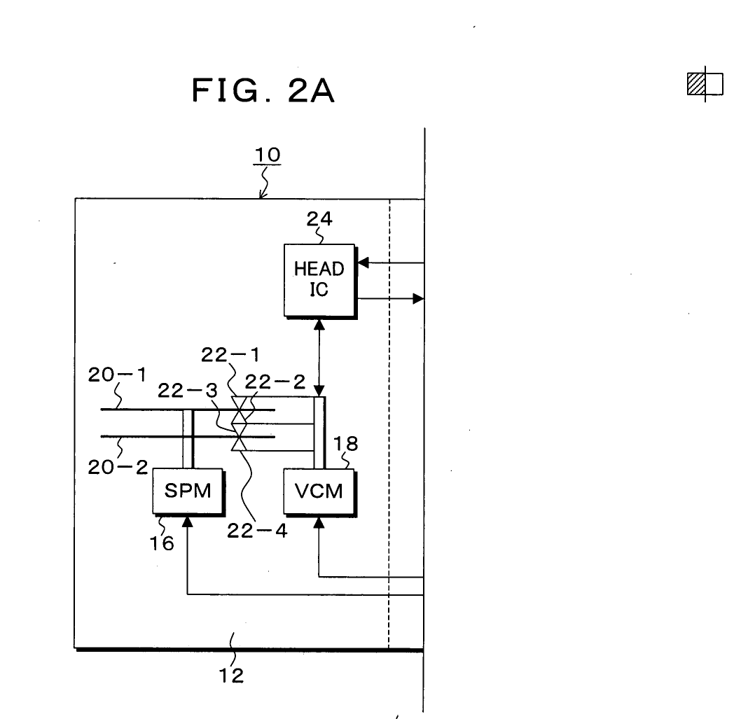

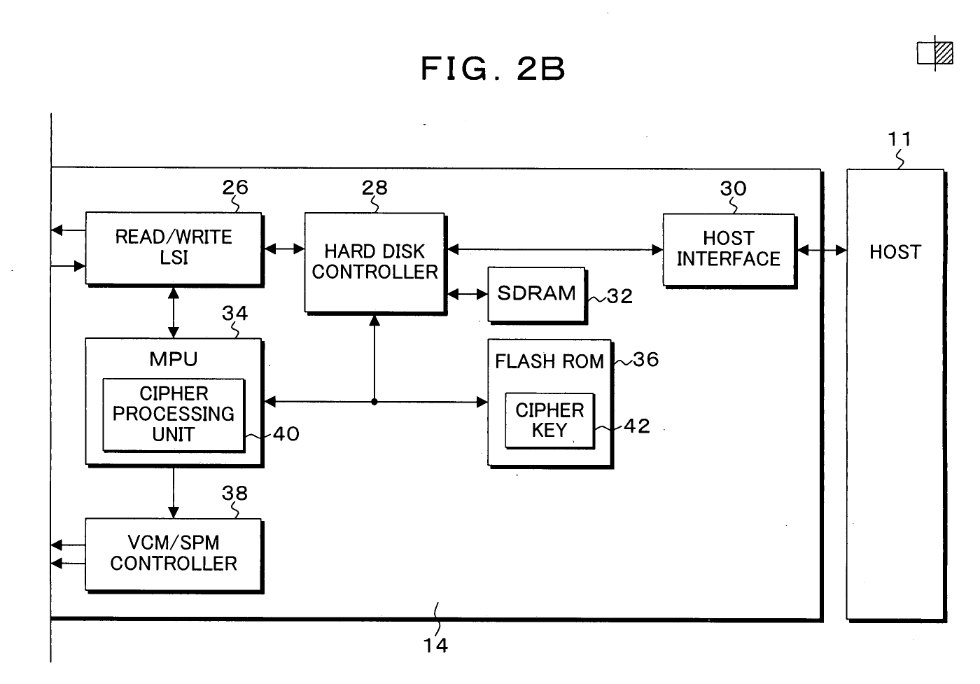

FIGS. 2A and 2B show another embodiment of the magnetic disk apparatus to which the present invention is applied, and this embodiment is wherein the encoding process is executed by a program. In other words, in the embodiment of FIGS. 2A and 2B, the encoding processing unit 40 which is provided between the hard disk controller 28 and the host interface 30 of FIGS. 1A and 1B is removed, and, instead of that, the encoding processing unit 40 which is achieved by executing the program is provided to MPU 34. Also in this encoding processing unit 40 in MPU 34, the write data from the host interface 30 is received from the hard disk controller 28, encoded with key codes “a1 to an” of the cipher key 42 in the flash ROM 36, and written on the magnetic disk via the write system. Also, when the encoded read data written by the magnetic disk is output from the hard disk controller 28, the encoding is decoded by the encoding processing unit 45 provided to MPU 34 using key codes “a1 to an” of the cipher key 42 in the flash ROM 36, and the decoded read data is transferred to the host 11 via the host interface 30. In this way, in the magnetic disk apparatus of the present invention, it is possible to define whether the encoding processing unit 40 is constituted by hardware as shown in FIGS. 1A and 1B, or the encoding processing unit 40 is constituted by the program as shown in FIGS. 2A and 2B, as appropriate.

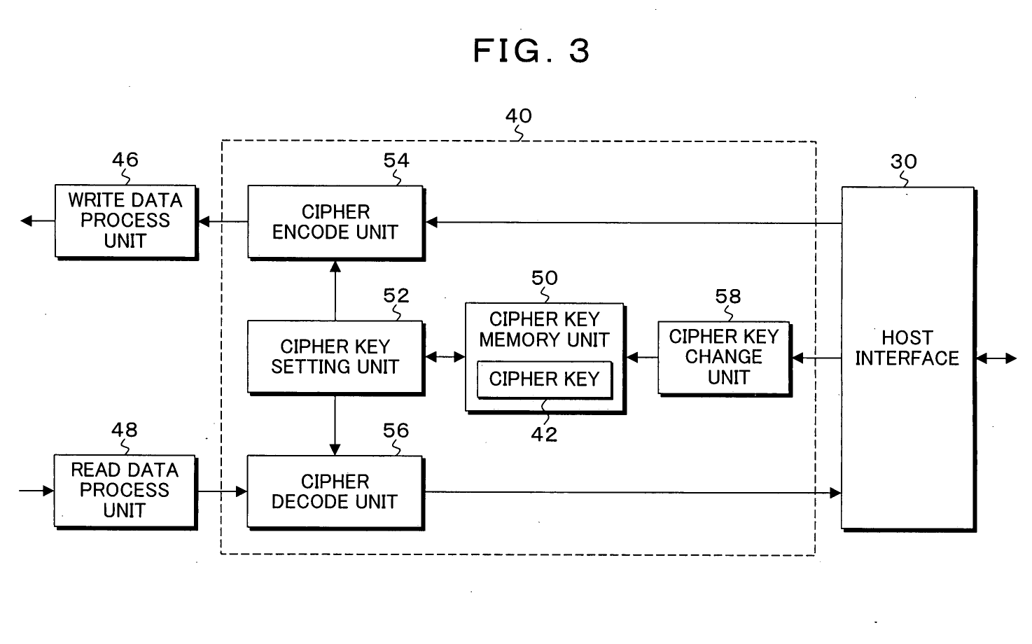

FIG. 3 is a block diagram of a functional structure of the encoding processing unit 40 of the present invention. This functional structure of the encoding processing unit 40 is achieved by functions of a circuit unit when it is constituted by hardware shown in FIGS. 1A and 1B or, in the case that it is the program shown in FIGS. 2A and 2B, achieved by process functions of the program. In FIG. 3, the encoding processing unit 40 is provided between the host interface 30 and the write data processing unit 46/the read data processing unit 48. Here, the write data processing unit 46 represents the write systems of the hard disk controller 28 and the read/write LSI 26 in FIGS. 1A and 1B and FIGS. 2A and 2B together, and on the other hand, the read data processing unit 48 represents the read systems of the read/write LSI 26 and the hard disk controller 28 together as well. The encoding processing unit 40 is comprised of a cipher key memory unit 50, a cipher key setting unit 52, a cipher encode unit 54, a cipher decode unit 56 and a cipher key change unit 58. In this embodiment, the cipher key memory unit 50 is achieved by the flash memory 36 as nonvolatile memory shown in FIGS. 1A and 1B and FIGS. 2A and 2B, and the key codes “a1 to an” have been stored in advance by the special command in the manufacturing stage of the magnetic disk apparatus, as the cipher key 42. The cipher encode unit 54 encodes the write data input from the host 11 via the host interface 30, using the cipher key 42 in the cipher key memory unit 50 set by the cipher key setting unit 52, and stores the encoded write data through the write data processing unit 46 into the magnetic disk medium. The cipher decode unit 56 input the encoded read data read out from the magnetic disk medium and repeated by the read data processing unit 48, decodes the data using the cipher key 42 read out from the cipher key memory unit 50, which is set by the cipher key setting unit 52, and transfers the decoded read data to the upper host 11 through the host interface 30. Further, when the host 11 equipped with the magnetic disk apparatus 10 of the present invention is discarded, the cipher key change unit 58 changes the key codes “a1 to an” of the cipher key 42 stored in the cipher key memory unit 50 into the cipher key which has other key codes “b1 to bn” in order to collectively discard the stored data residing in the user storage area on the magnetic disk apparatus.

In this embodiment, the cipher key change unit 58 executes the change of the cipher key 42 in the cipher key memory unit 50 by receiving the special command for changing the cipher key, which is transferred from the host 11 side, via the host interface 30. The special command for changing the cipher key from the host 11 to the cipher key change unit 58 is, for example, the special command used in the manufacturing stage of the magnetic disk apparatus of the present invention and is independent from OS of the host 11, therefore the cipher key 42 in the cipher key memory unit 50 will not changed by commands from OS of the host during operation. The encoding used in the encoding processing unit 40 is, for example, as follows.

(1) DES

DES encoding is modification of the method which was submitted by IBM (R) in 1977 when the National Bureau of Standards (NBS) issued a public request for proposals for a Data Encoding Standard. In DES encoding, data is handled as blocks of 64 bit, and the cipher key is comprised of seven (7) byte of key data and one (1) byte of odd parity.

(2) CAST-128

CAST-128 encoding is block encoding which was developed by Carlisle Adams and Stafford Travarses of Entrust Technologies Inc. A block length is 64 bit, and a key length is variable from 1 to 128 bit and processed in 12 to 16 rounds. This algorithm is patented, but that it can be used freely is clearly stated, and disclosed as RFC 2144.

(3) Other Encoding Algorithms Registered in ISO/IEC 9979

To the encoding processing unit 40 of the present invention, aforementioned encoding algorithms may be directly applied, or the write data may be encoded by, for example, DES algorithm after adding random redundancy to it in the cipher key change unit 58, and for the read data, the data may be output by removing redundancy after decoding with DES algorithm or the like in the cipher decode unit 56. In this way, by adding the random redundancy when the data is encoded, security is further increased, because in case that the encoding is cracked, the data has become senseless with the redundant data.

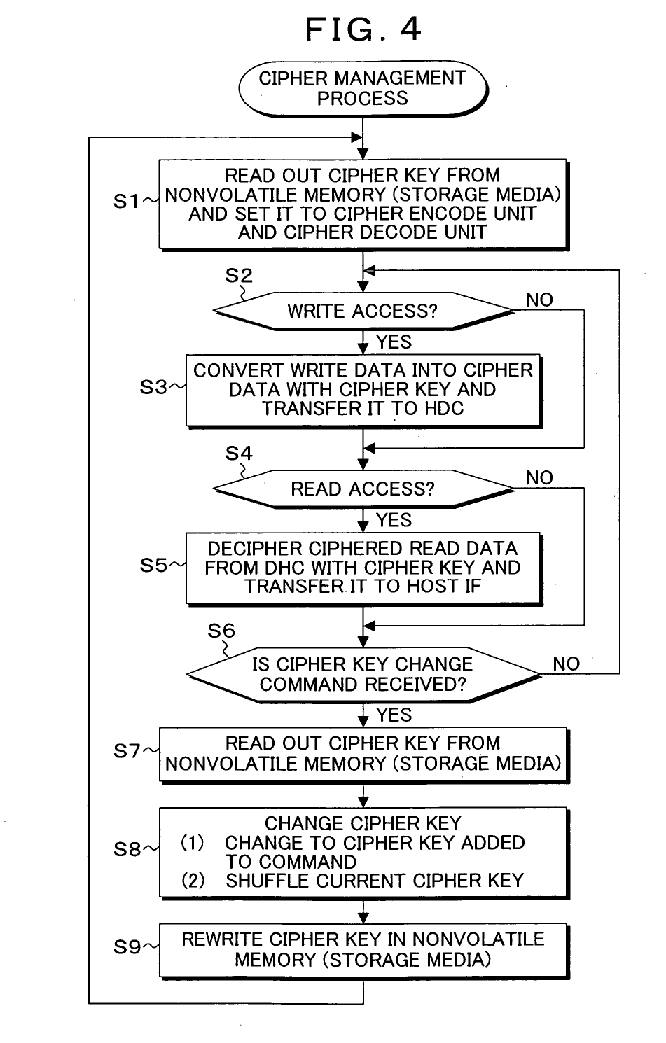

FIG. 4 is a flowchart showing a process procedure according to the encoding processing unit 40 of FIG. 3. This flowchart illustrates a process procedure of the program which achieves the encoding processing unit 44 provided to MPU 34 of FIGS. 2A and 2B as well. This procedure of the encoding process is executed at the time of power-on start of the magnetic disk apparatus and comprised of following process steps.

Step S1: Read out key codes “a1 to an” of the cipher key stored in advance from nonvolatile memory which is the cipher key memory unit and set it to the cipher encode unit 54 and cipher decode unit 56.

Step S2: Check write access, and if there is write access in which a write command and write data is transferred from the host 11, proceed to step S3, otherwise proceed to step S4.

Step S3: convert the write data into encoded data with the key codes “a1 to an” of the cipher key, transfer it to the hard disk controller 28 side and write it on the magnetic disk medium.

Step S4: Check whether there is read access or not, and if there is read access according to a read command, proceed to step S5, otherwise proceed to step S6.

Step S5: Decrypt the encoded read data output from the hard disk controller using the key codes “a1 to an” of the cipher key and transfer it from the host interface 30 to the host 11.

Step S6: Check reception of a cipher key change command, and if the command is received, proceed to step S7, otherwise back to step S2.

Step S7: Read out the key codes “a1 to an” of the cipher key from the nonvolatile memory.

Step S8: Change the key codes “a1 to an” of the cipher key in the nonvolatile memory with the cipher key change command (special command) received from the host 11 into key codes which will be another cipher key, for example, “b1 to bn”. This change of the cipher key is:

(1) change to the cipher key added to the cipher key change command; or

(2) change to another cipher key by processing the current cipher key, for example shuffling.

Step S9: Rewrite the cipher key in nonvolatile memory to the changed cipher key.

For shuffling in the cipher key change process in step S8, any suitable shuffling may be applied, such as reversing bits randomly in the key codes “a1 to an” of the cipher key before changing, for example dividing into byte units and replacing position, or performing byte division, replacing position and utilizing exclusive logical sum with the original key codes. In other words, to change the cipher key in the present invention, any technique may be used as long as the cipher key before changing is lost and a new cipher key differing from the key before changing is generated.

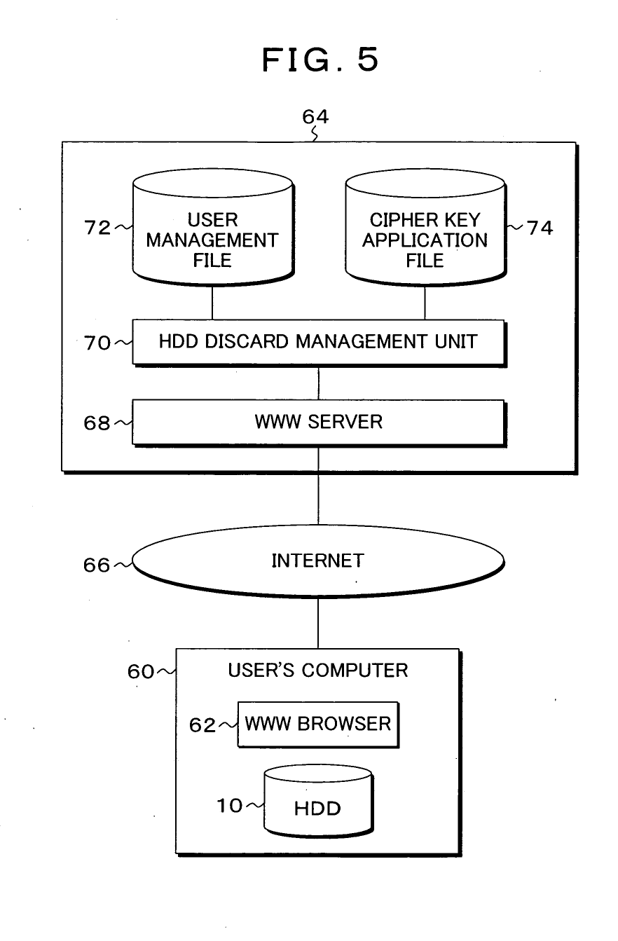

FIG. 5 is an explanatory diagram of network environment providing a cipher key change tool to the magnetic disk apparatus of the present invention. In FIG. 5, if a user's computer 60 equipped with the magnetic disk apparatus 10 of the present invention is discarded, this is executed by downloading a tool for changing the cipher key from, for example, a manufacturer's server 64 on the internet 66, using a WWW server in the user's computer (host) 60. Therefore, the manufacturer's server 64 is provided with a WWW server 68, a HDD discard management unit 70, a user management file 72 and a cipher key change application file 74.

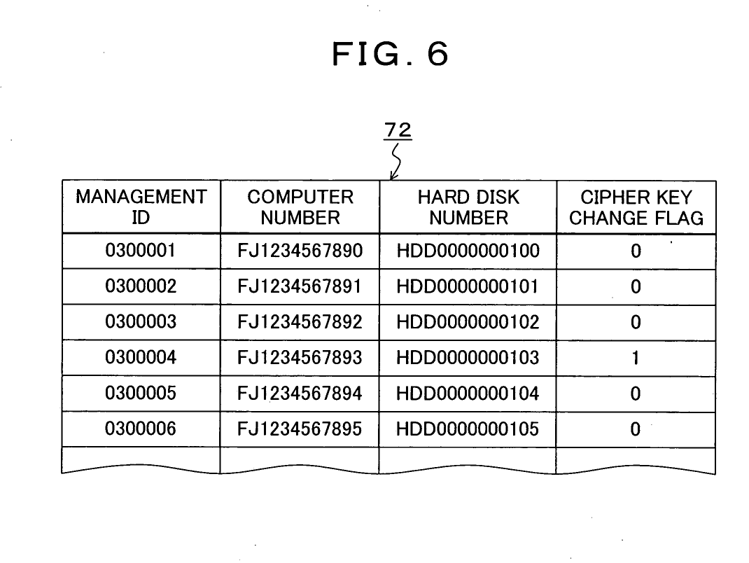

FIG. 6 is an example of the user management file 72 in FIG. 5; a management ID, a computer number and a hard disk number are generated and registered in the manufacturing stage of the computer; and a cipher key change flag is provided, which is 0 if there is no change and is set to 1 if the change is executed in response to a request from the user by downloading the cipher key change tool from the cipher key change application file 74. In this example, for a management ID “0300004”, the cipher key change flag is set to “1” and indicates that the cipher key change process is executed, and this means that this computer is discarded or reused by another user.

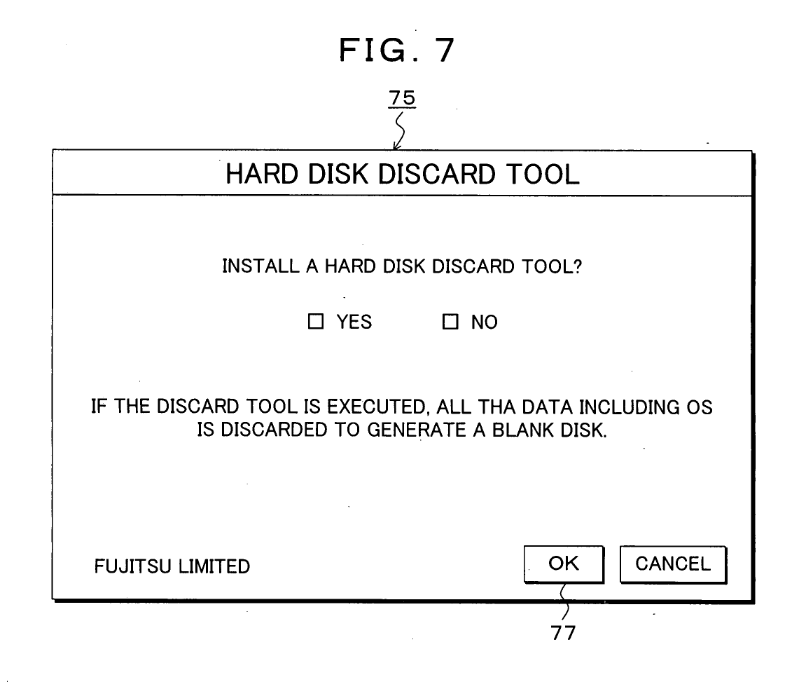

FIG. 7 is an explanatory diagram of a hard disk discard tool operating screen 75 which is displayed when the manufacturer's server 64 of FIG. 5 is accessed by a WWW browser 62 in the user's computer 60. On this hard disk discard tool operating screen 75, to the display of “Install a hard disk discard tool?”, if a check box for “yes” is clicked and OK button 77 is manipulated, the hard disk discard tool downloaded from the manufacturer's server is executed in the user's computer 60, and the special command for changing the cipher key stored in the magnetic disk apparatus 10 is issued to change the cipher key. Once the cipher key in the magnetic disk apparatus 10 has been changed this way, since the cipher key is changed when the user's computer 60 is turned off to shut down after changing and then turned on again, all the data including OS stored in the magnetic disk medium at this point of time will be decoded by the cipher key after changing and completely senseless data will be decoded due to different cipher key, and consequently, the OS will not be booted up by reading the magnetic disk apparatus, therefore the user' computer will be in the same condition as the completely unused condition in which OS is not installed. Therefore, if the user's computer is discarded and if a third party starts up the user's computer, the user's computer will not operate at all and outflow of the data will not occur. Also, if the user's computer is disassembled and if the cipher key of the magnetic disk apparatus is obtained by some operation, the data stored in the magnetic disk apparatus is data which has been encoded with the cipher key before changing, which is already lost, and can not be decoded with the cipher key obtained at this point of time, therefore if the cipher key after changing is known, outflow of the data will not occur. On the other hand, when the user's computer discarded by executing the cipher key change is reused by another user, just like a new computer completely unused, by installing OS and storing the encoded OS into the magnetic disk medium, encoding and decoding according to the cipher key after changing will be performed in processes after that and it is possible to utilize it in the same way as a normal computer in which the encoding process is not performed. Also, since it is possible to obtain the hard disk discard tool on the internet as shown in FIG. 5 and change the cipher key of the magnetic disk apparatus 10 provided to the user computer 60, the user does not have to manage the cipher key at all and may obtain and execute the hard disk discard tool on the internet as a procedure when discarding the user's computer. As another technique for providing these hard disk discard tools to users, it is possible to store it in a floppy disk (R) or the like and provide it to the user, but obtaining on the network is easier and more reliable then this case because management of the medium is not necessary.

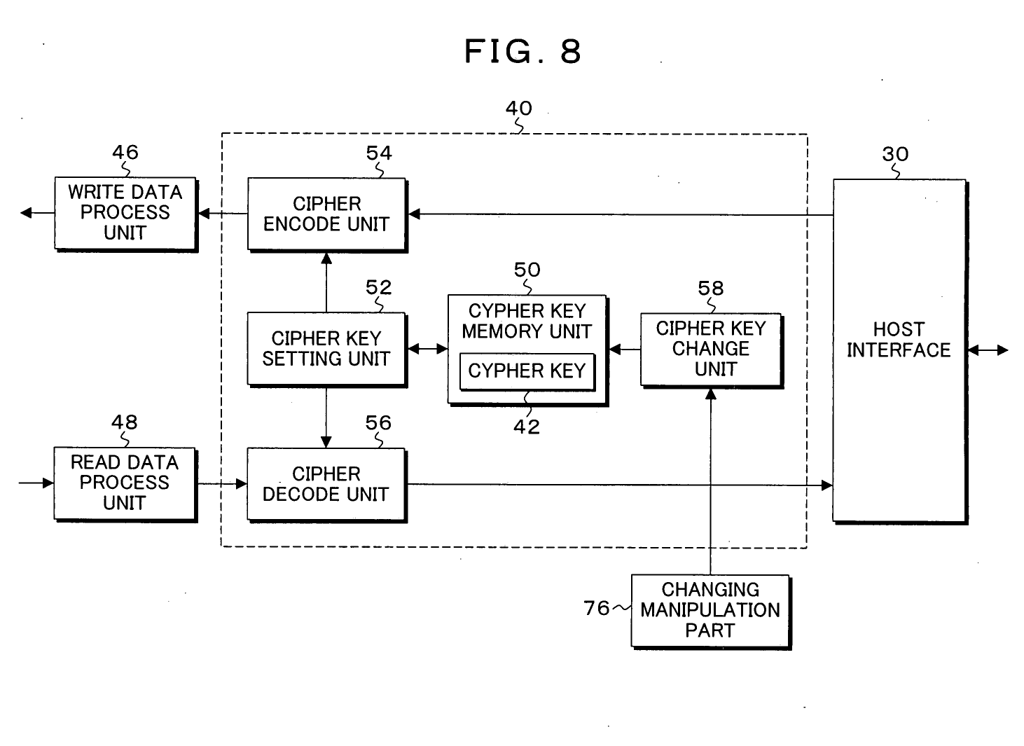

FIG. 8 is a block diagram of another embodiment of the present invention, in which the cipher key is changed with physical manipulation in the apparatus. In this embodiment, a changing manipulation part 76 is provided within the magnetic disk apparatus for the encoding processing unit 40. As the changing manipulation part 76, any suitable physical manipulation part may be used, such as a DIP switch provided to the control board 14 in FIGS. 1A and 1B and FIGS. 2A and 2B, a signal input pin or a jumper line to which manipulation and input is performed by disconnection. When the changing manipulation part 76 is physically manipulated, event input to the cipher key change unit 58 is performed, and this event input has the same function as the special command operating the cipher key change unit 58, therefore the cipher key change unit 58 changes the key codes “a1 to an” of the cipher key 42 stored in the cipher key memory unit 50 into other key codes, for example, “b1 to bn”. In this case of changing the key codes, since it is not secure to store other key codes of the cipher key in advance, it is desirable to perform the change of the cipher key in which the key codes “a1 to an” of the cipher key before changing are changed into other key codes by operation such as shuffling.

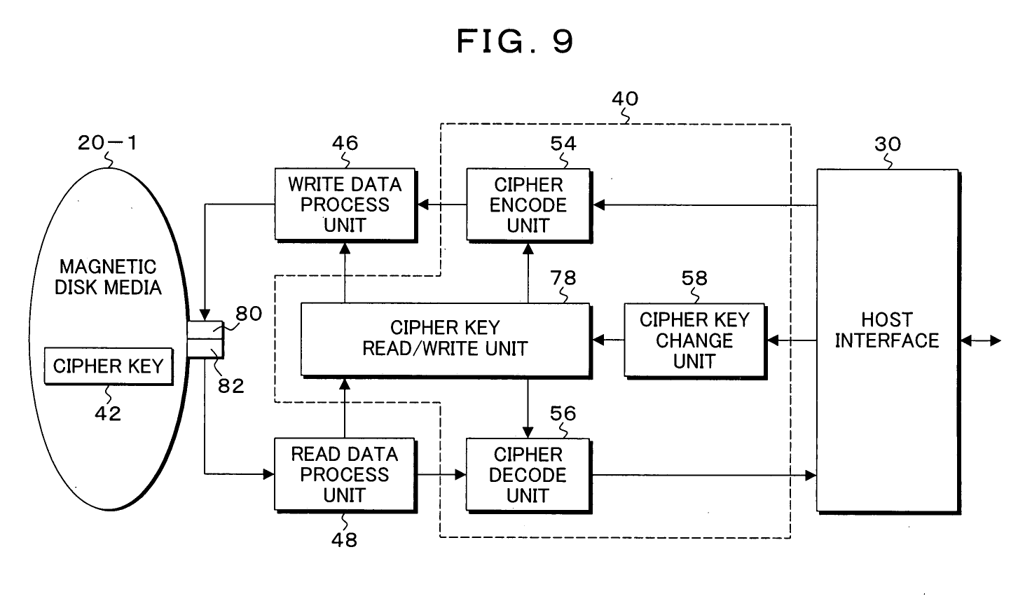

FIG. 9 is a block diagram of another embodiment of the present invention, in which the cipher key is stored in the magnetic disk medium. In FIG. 9, the cipher key 42 is stored in a recording area other than the user storage area on the magnetic disk medium 20-1, or specifically, the cipher key 42 is stored in so called system area which is used for storing various parameters in the manufacturing stage of the magnetic disk apparatus. Corresponding to such storage of the cipher key 42 in the magnetic disk medium 20-1, the encoding processing unit 40 is provided with a cipher key read/write unit 78. The cipher key read/write unit 78 reads out the cipher key 42 stored in the system area of the magnetic disk medium 20-1 via the read data processing unit 48 at the time of power-on start of the magnetic disk apparatus and sets it to the cipher encode unit 54 and the cipher decode unit 56. Also, in this embodiment, when the special command for changing the cipher key is provided from the host 11 via the host interface 30, the cipher key change unit 58 reads out the cipher key 42 from the magnetic disk medium 20-1 in read operation of the cipher key read/write unit 78, rewrites it to a cipher key after changing and writes this into the system area of the magnetic disk medium 20-1 through the write data processing unit 46 to change the cipher key.

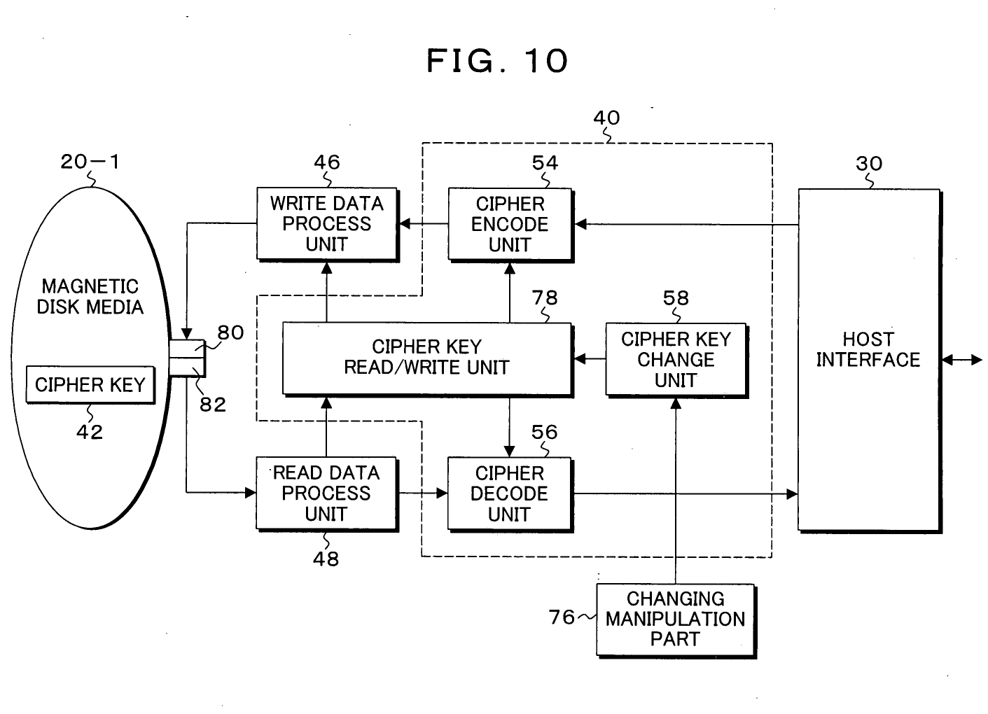

FIG. 10 is a block diagram of another embodiment of the present invention, in which the cipher key is changed with the changing manipulation part 76 in the apparatus in the case that the cipher key is stored in the magnetic disk medium as FIG. 9. As the changing manipulation part 76 of this case, any suitable physical manipulation part is used, such as a DIP switch provided on the control board 14 side in FIGS. 1A and 1B and FIGS. 2A and 2B, a signal input pin or a jumper line to which manipulation and input is performed by disconnection, as is the case with the embodiment of FIG. 8. In the above embodiment, although encoding and decoding of data is executed by providing the encoding processing unit 40 between the host interface 30 and the hard disk controller 28, the encoding process may be executed to the formatted data for memory readout from the magnetic disk apparatus by providing the encoding processing unit 40 between the hard disk controller 28 and the read/write LSI 26. In other words, in the present invention, the encoding may be executed in any suitable stage as long as it is before storing into the magnetic disk medium, and also for the readout from the magnetic disk medium, the decoding of the encoded data may be executed in any suitable location if there is data after readout. According to the present invention described above, data on record medium is discarded by simply changing a cipher key recorded and held within a magnetic disk apparatus, and without performing time-consuming erasure in the whole data area of the record medium, it is possible to certainly prevent outflow of data and easily discard data. Also, in this invention, since encoding of data in the case of writing and decoding of the encoded data in the case of reading are performed in a interface portion, a host side located outside of the interface does not have to be aware of the encoding process in the magnetic disk apparatus of the present invention and is able to handle the magnetic disk apparatus in the same way as the conventional apparatus, therefore the magnetic disk apparatus of the present invention can replace the conventional magnetic disk apparatus, regardless of the built-in encoding process. Further, if the cipher key is picked up from nonvolatile memory or record medium in the magnetic disk apparatus of the present invention which has been discarded after changing the cipher key and the data is read out, since the data in the record medium is encoded with the cipher key before changing and the picked up cipher key has been changed, security of the data is completely assured. Further, since the magnetic disk apparatus of the present invention stores the encoded data and the cipher key within the apparatus, a user does not have to manage the cipher key in general use, so the user's burden associated with the cipher key is not generated. Further, if the cipher key is changed, the magnetic disk apparatus will return to the unused condition and will be able to be reused by installing OS in a host. Also, the present invention includes any alteration without impairing the object and the advantages thereof and is not limited by the numerical values indicated in the above embodiments.

What is claimed is:

1. A magnetic disk apparatus comprising:
a cipher key memory unit which stores a cipher key used for encoding and decoding data;
a cipher encode unit which encodes data input via an interface from an upper apparatus using the cipher key, the cipher encode unit recording the encoded data onto a record medium;
a cipher decode unit which decodes the encoded data read out from the record medium using the cipher key, the cipher decode unit outputting the decoded data via the interface to the upper apparatus; and
a cipher key change unit which changes a cipher key stored in the cipher key memory unit.

2. The magnetic disk apparatus according to claim 1, wherein
the cipher key memory unit stores a predefined cipher key written in at a stage of manufacturing the apparatus.

3. The magnetic disk apparatus according to claim 1, wherein
the cipher key memory unit is a nonvolatile memory.

4. The magnetic disk apparatus according to claim 1, wherein
the cipher key memory unit is a medium area other than a user recording area of the record medium.

5. The magnetic disk apparatus according to claim 1, wherein
the cipher key change unit changes the cipher key stored in the cipher key memory unit when all the record data residing in a user recording area on the record medium is discarded collectively.

6. The magnetic disk apparatus according to claim 1, wherein
the cipher key change unit changes the cipher key in the cipher key memory unit in response to a special command other than a command system for the upper apparatus.

7. The magnetic disk apparatus according to claim 1, wherein
the cipher key change unit changes the cipher key in the cipher key memory unit in response to a special command from a cipher key change application installed in the upper apparatus.

8. The magnetic disk apparatus according to claim 1, wherein
the cipher key change unit changes the cipher key in the cipher key memory unit in response to a special command from a cipher key change application installed by the upper apparatus via network.

9. The magnetic disk apparatus according to claim 1, wherein
the cipher key change unit changes the cipher key in the cipher key memory unit by recognizing a physical event manipulation in the apparatus.

10. The magnetic disk apparatus according to claim 1, wherein
the cipher key change unit changes the cipher key by generating a new cipher key through a process of, e.g., shuffling of the cipher key stored in the cipher key memory unit.

11. The magnetic disk apparatus according to claim 1, wherein
the cipher key change unit changes a cipher key stored in the cipher key memory unit, into another cipher key added to a cipher key change command from the upper apparatus.

12. A cipher processing method for a magnetic disk apparatus, comprising:
a cipher key memory step of storing in a memory unit a cipher key used for encoding and decoding data;
an encoding/recording step of converting data input via an interface from an upper apparatus into encoded data using the cipher key, and storing the encoded data onto a record medium;
a decoding/readout step of decoding the encoded data read out from the record medium using the cipher key, and outputting the decoded data via the interface to the upper apparatus; and
a cipher key change step of changing a cipher key stored in the cipher key memory unit.

13. The cipher processing method for a magnetic disk apparatus according to claim 12, wherein
the cipher key change step includes changing the cipher key stored in the cipher key memory unit when all the record data residing in a user recording area on the record medium is discarded collectively.

14. A program operable to cause a computer incorporated in a magnetic disk apparatus to execute:
a cipher key memory step of storing in a memory unit a cipher key used for encoding and decoding data;
an encoding/recording step of converting data input via an interface from an upper apparatus into encoded data using the cipher key, and storing the encoded data onto a record medium;
a decoding/readout step of decoding the encoded data read out from the record medium using the cipher key, and outputting the decoded data via the interface to the upper apparatus; and
a cipher key change step of changing a cipher key stored in the cipher key memory unit.

15. The program according to claim 14, wherein
the cipher key change step includes changing the cipher key stored in the cipher key memory unit when all the record data residing in a user recording area on the record medium is discarded collectively.
